(19) United States
(12) Patent Application Publication
(10) Pub. No.: US 2005/0224129 A1
(43) Pub. Date: Oct. 13, 2005

(54) Skinned structures of air hardenable or liquid quench hardenable steel plate and methods of constructing thereof

(76) Inventor: Davor Jack Raos, Vista, CA (US)

Correspondence Address: Timothy J King, PO Box 3424, Fayville, MA, 01745, US

(21) Appl. No.: 10/521,426

(22) PCT Filed: Jul. 1, 2002
(86) PCT No.: PCT/US02/20889

§ 371 Date: Dec. 30, 2004

(30) Foreign Application Priority Data
Jun. 29, 2002 (US) 60301937

(51) Int. Cl. B23K 31/02

(52) U.S. Cl. 138/150; 228/146; 228/147

(57) ABSTRACT

The present invention provides skinned structures of air or liquid quench hardenable steel plates or sheets, and methods of constructing such structures. The present invention also provides hardened skinned structures made from a plurality of air or liquid quench hardenable steel plates or sheets that are made by such methods.

### RELATED APPLICATIONS

Filed concurrently herewith is an application entitled SEAM-WELDED AIR HARDENABLE STEEL TUBING (Ref No. 4800-0004).

### FIELD OF THE INVENTION

The field of the present invention is skinned structures of air hardenable or liquid quench hardenable steel plate, including ships, aircraft, storage tanks, and other structures, and methods for creating such structures.

### BACKGROUND OF THE INVENTION

A method of creating skinned structures of air or liquid quench hardenable steel plate has not been proposed in the prior art. The major technical challenge to creating such a structure is to devise a system for efficiently heat-treating the structure to induce sufficient hardening, and thus strength, in the material. No such system has been proposed in the prior art.

To create a structure of air hardenable steel, another technical challenge in addition to lack of a viable heat-treating method remains unsolved in the prior art: a method is needed for the elimination of cracking of the weld zone following seam-welding of the plates. Heretofore, seam-welding of air hardenable steel without introducing cracks has been possible only with relatively short pieces, where cracking can be reasonably controlled through the use of a simple, imprecise pre-heating process. For longer seams, however, such as those that would be needed to weld plates in large, skinned structures, this method of controlling cracking becomes increasingly inadequate.

The prior art gives no indication that these problems were solved, or indeed that anyone had recognized that great benefits could be obtained through the application of these materials to the construction of skinned structures if these problems could be solved.

Materials currently in use for skinned structural applications, including mild steel, high strength steels, aluminum alloys, and exotic materials such as carbon composites and titanium, serve the basic need but force the engineer and ultimately the users of such structures to sacrifice one or more desirable features. For example, one of the most undesirable trade-offs is that between cost and strength-to-weight ratio: the costs of these materials generally increase disproportionately to their strength-to-weight ratios.

Ships are traditionally constructed of welded carbon steel plates over carbon steel frames. This type of construction predominates primarily due to its low initial cost. However, negative trade-offs for the initial low expense exist, including basic carbon steel's poor strength-to-weight ratio and its susceptibility to corrosion. To achieve the required strength, the steel plates and frames must be of a substantial thickness, resulting in a heavy structure. The excess weight means a large power system for a given payload is required, leading to high fuel consumption and emissions. Also, due to the steel's susceptibility to corrosion, these ships require frequent repainting and maintenance.

Many storage tanks, such as mobile ones drawn by truck or train, are traditionally constructed of welded non-hardening stainless steel plate over frames of the same material. This material is corrosion-resistant, but has only a moderate strength-to-weight ratio, requiring the use of thicker plates with an associated higher cost. For mobile tanks, the excess weight of the thicker plate results in a low ratio of payload to vehicle weight, propulsion system size, and fuel consumption and emissions.

Some storage tanks, such as large stationary tanks, are traditionally constructed of welded carbon steel plates over frames of the same material. Although this material has a low initial cost, it is heavy and prone to rusting. If a storage tank is prefabricated off-site, the heavy weight increases the cost of shipping the tank to its permanent location. The predisposition to rusting adds to maintenance costs, shortens the life of the tank, and mars its appearance.

Large aircraft are traditionally constructed of riveted aluminum plates over aluminum frames. This system of construction serves the basic need, but is expensive. Aluminum has a good strength-to-weight ratio, but only moderate corrosion resistance. Due to aluminum's tendency to fatigue under flight loads and the cyclic stresses induced by cabin pressurization, an extra margin in wall thickness must be engineered into the aircraft body.

Many other skinned structures (for example, submarines, torpedoes, hydrofoils, shipping containers, moving vehicles, military armored vehicles, trains, building walls, large missiles, dams, heat exchanger casing and space vehicles) are also either extremely expensive or have performance limitations due to the characteristics of conventional structural materials and the related methods of manufacturing.

### SUMMARY OF THE INVENTION

The present invention provides ships and similar skinned structures of welded air hardenable or liquid quench hardenable steel plate, and methods for constructing such structures. These methods include a system for efficiently heat-treating such structures to induce sufficient hardening, and thus strength, in the steel, and means for eliminating cracking of the weld zone following seam-welding of the plates, if necessary. The specific combination of steps and materials set forth herein have never before been identified as together leading to a quantum improvement in the strength/weight/cost ratio of skinned structures.

The preferred embodiment of the present invention is skinned structures of air hardenable stainless steel. This embodiment enables superior performance at a lower cost than currently available materials and methods have afforded for these applications.

When welded and heat-treated according to the method disclosed herein, air hardenable stainless steel has a very high strength-to-weight ratio, enabling skinned structures to be built lighter, yet as strong or stronger, than their conventional counterparts. Mobile structures, such as ships, mobile storage tanks, etc., would therefore be able to carry a larger payload for a given gross weight or propulsion system size than their conventional counterparts. Alternately, a smaller propulsion system could be employed to move a given payload, thus saving fuel and reducing emissions. In addition, the present invention would enable ships to carry more payload for a given set of external hull dimensions than conventional ships.

The present invention is a cost-effective method of building skinned structures that meet the applications' performance objectives. The alloying constituents of air hardenable stainless steel (iron, carbon, and chromium) are inexpensive and plentiful. Since the present invention yields a material with a higher strength-to-weight ratio than materials traditionally used in these applications, less material overall is needed for their construction. The ease, and therefore the cost, of construction is improved because air hardenable stainless steel plates are relatively light, thin, and easy to form. Plate welding can also be accomplished in fewer passes due to the thinner material. In cases where the structure is prefabricated in a factory, the capability of making a lightweight end product reduces the cost of shipping it to its permanent location.

Since the present invention makes it possible to produce a structure relatively inexpensively out of a material with very good corrosion-resistant properties, initial construction costs and/or maintenance costs over time can be reduced. In comparison to conventional carbon steel storage tanks and ships, for example, a dramatic improvement in corrosion-resistance can be realized, together with a moderate reduction in cost. In comparison to conventional non-hardenable stainless steel storage tanks, a given capacity corrosion-resistant pressure tank can be built at a substantially lower cost. For those applications where techniques like painting, zinc coating, or engineering thicker walls have traditionally been employed to anticipate corrosion, an additional weight and cost savings is realizable through the present invention. The inherent corrosion-resistant property of air hardenable stainless steel renders the extra expense and weight brought on by these techniques unnecessary.

Significant advances in large aircraft construction can be realized through the present method. In comparison to traditional materials and methods of construction, the present invention enables an aircraft with superior characteristics to be built for less expense. Air hardenable stainless steel is more resistant to corrosion than aluminum and is less expensive. Welding the aircraft skin, as proposed herein, means rivets can be eliminated and stress concentration reduced. Furthermore, such a skin is more resistant to puncture, such as that caused by explosive devices.

The present invention would also yield significant advantages in the construction of other skinned objects such as submarines, torpedos, hydrofoils, shipping containers, moving vehicles, military armored vehicles, trains, missiles, space vehicles, walls for buildings, dams, heat exchanger casing, etc.

### BRIEF DESCRIPTION OF THE FIGURES

FIG. 1 provides a top perspective view of an individual belt segment.

FIG. 2 provides a bottom perspective view of an individual belt segment.

FIG. 3 provides a top perspective view of a welded seam cooling rate control device.

FIG. 4 provides a bottom perspective view of a welded seam cooling rate control device.

FIG. 5 provides a front view of a ship hull in the process of heat treatment.

### DETAILED DESCRIPTION OF THE INVENTION

The present invention provides ships and similar skinned structures of air hardenable or liquid quench hardenable steel plates, and methods that make the production of such structures possible for the first time.

The preferred embodiment of the present invention is skinned structures of air hardenable stainless steel due to its superior performance characteristics and lower cost as compared with other currently available hardenable steels. However, it is anticipated that various new formulations of air and liquid quench hardenable steel, including both new non-stainless and new stainless types, may be developed in response to the availability of the new methods of construction disclosed herein. Since these new formulations may indeed be competitive with, or even superior to, currently available air hardenable stainless steel for some skinned structural applications, and insofar as these new steels could not be used in the construction of skinned structural applications without the methods of production taught herein, it is an object of the present invention to use the methods herein described to construct skinned structures of any air or liquid quench hardenable steel.

It is likely, for example, that the carbon content of 400-series type stainless steel will be specified at percentages between the present 400 series intervals, and held to tighter tolerances. For example, 410 contains 0.12% carbon with approximately ±0.02 percent tolerance and 420 contains 0.25% carbon with approximately ±0.04 percent tolerance. A new specification, labeled 415P perhaps, with a carbon content of 0.19% and a tolerance of ±0.01 percent may be created.

Also, it is anticipated that new hardenable steels containing elemental constituents different from current formulations may be developed in order to improve various characteristics of the steels for various specific skinned structural applications. Insofar as these new steels could not be used for skinned structural applications without the methods of production taught herein, skinned structures of these steels would be considered to fall within the scope of this patent.

A detailed description of the preferred methods for constructing skinned structures of hardenable steels follows. This description uses the example of a ship hull skin, however the same method could be applied to the construction of other skinned structures as well, such as those applications listed herein.

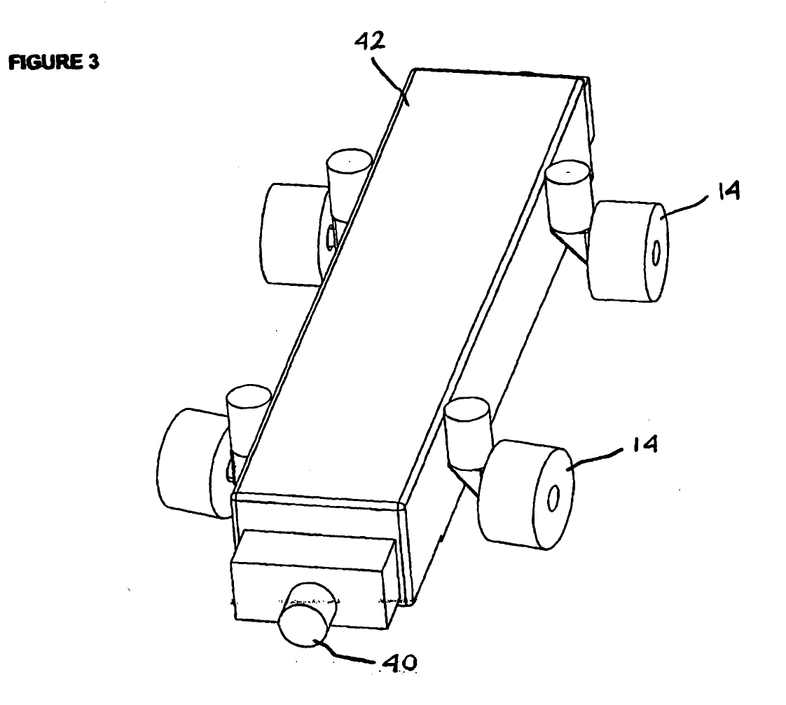

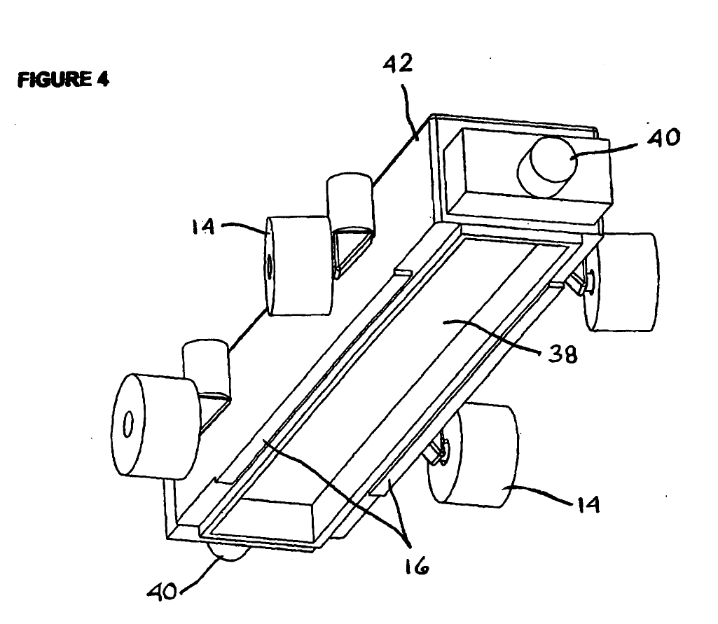

Air hardening stainless steel plates in an annealed state are formed and welded over a framework. The welding torch is closely followed by an automatic device that positively controls the cooling rate of each seam such that the heat-affected zone is prevented from fully hardening and thus cracking. FIGS. 3 and 4 provide perspective views of such a cooling rate control device. Steerable wheels 14, seam tracking optical sensor 40 and temperature control device 38 are mounted on cooling rate control device housing 42. The cooling rate is positively held to a profile that prevents the weld zone from fully hardening and becoming brittle, so that welding-induced stresses do not crack the weld region. The entire hull skin, or a section thereof, is thus welded into a continuous shell.

The hull skin thus welded is then subjected to heat treating, by the following means, in order to reach a high strength and high stiffness condition. A heat producing device is passed over the surface of the hull in such a way that a continuous band of heat, reaching from one rail, down the side, across the bottom and up the opposite side to the other rail, progresses from one end of the hull to the other. As the band of heat passes a given hull area, the air hardenable stainless steel plate material cools and hardens. This method allows the entire hull skin to be brought to a uniform high strength condition, without the use of a large and impractical heat treat furnace.

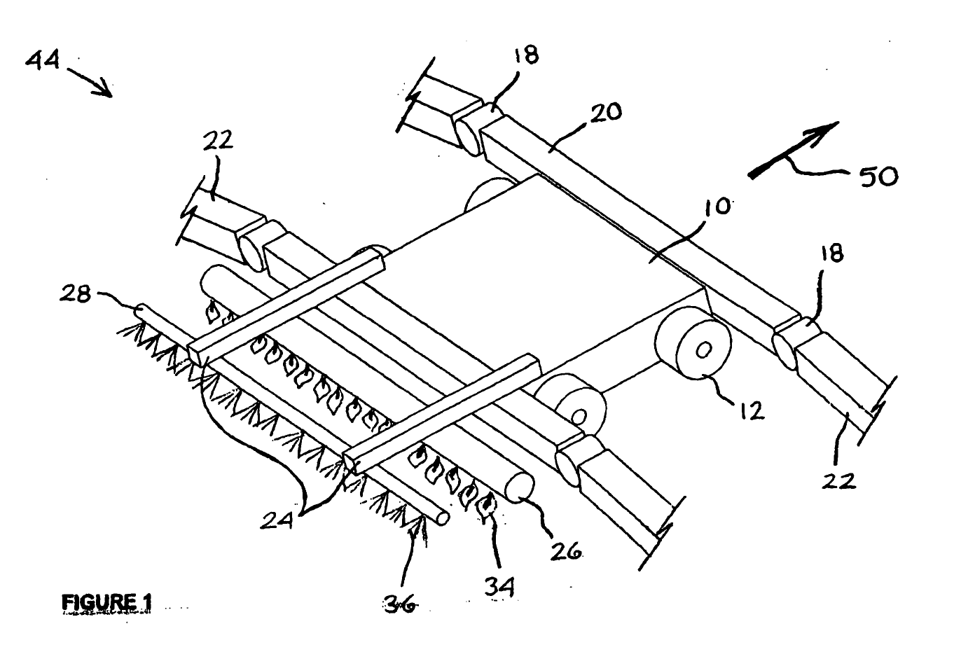

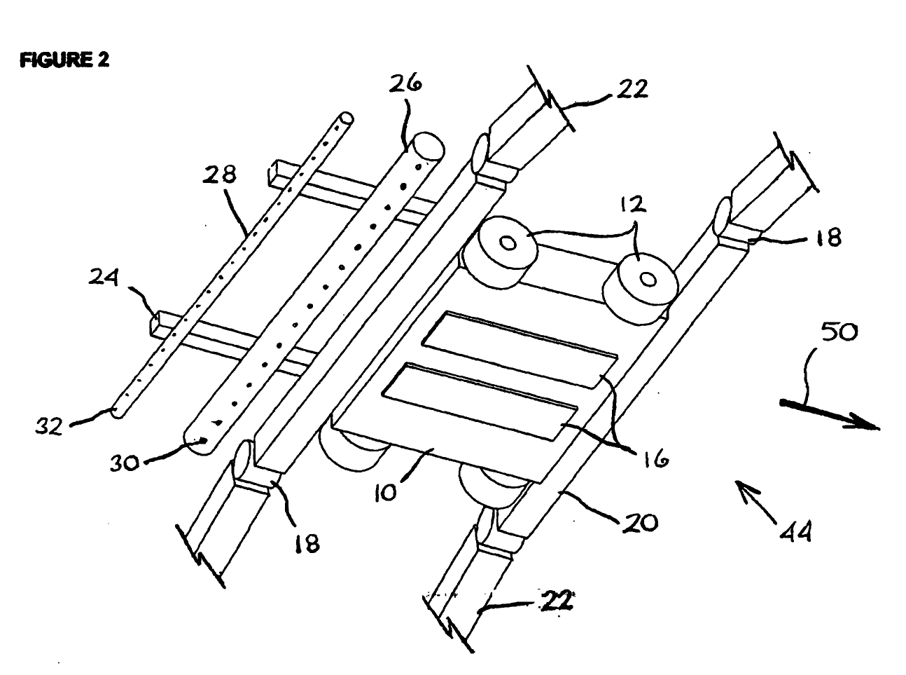

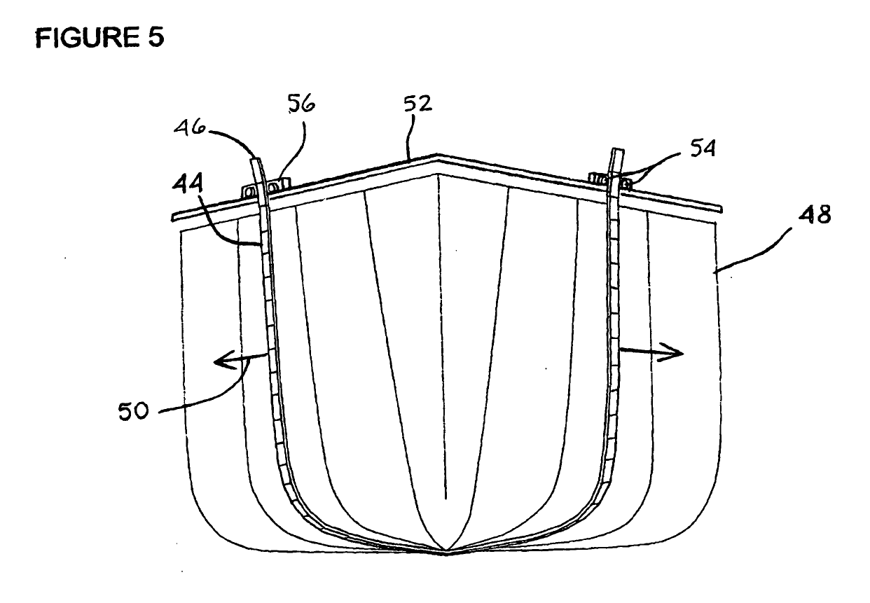

In the preferred embodiment, the heat inducing device is configured as a series of wheel-equipped segments connected to one another such that the assemblage forms a flexible belt that can follow the contour of the hull as its curvature changes from one end to the other. FIG. 5 shows a heat treating belt 46 in position on a ship hull and indicates the direction 50 of belt travel. After the belt finishes its pass over the length of the structure, the entire hull skin 48 is in a uniform high strength condtion. FIGS. 1 and 2 show a close-up view of one heat-treating belt segment 44 with frame arms 20 mounted on belt segment drive housing 10. Frame arms 20 are connected to adjacent belt segment frame arms 22 by hinge joints 18. Each segment 44 of the belt is further equipped with heat producing means such as gas fueled torches or electric induction coils. FIGS. 1 and 2 represent this heat producing means as a torch bar 26 with flames 34 emanating from gas orifices 30. Torch bar 26 is mounted by means of support arms 24 to belt segment drive housing 10. As shown in FIG. 5, a device 56 for taking up the slack in the belt as it progresses is provided for. The belt is held in close contact to the surface of the hull by magnets or other means, and is further supported by slack take-up device 56, which rolls on support wheels 54 along a support track 52 near the ship's rails. FIG. 4 shows magnets 16 mounted on the underside of the cooling device housing 42 for the purpose of holding the belt in close-coupled relationship to the hull. Alternately, the belt segment drive wheels 12, shown in FIGS. 1 and 2, could include embedded magnets for the purpose of holding the belt in close-coupled relationship to the hull. Means for advancing the belt from one end of the hull to the other is provided for. If necessary, cool air blast—or liquid spray cooling—nozzles may be mounted on the trailing edge of the belt to increase the rate of cooling such that sufficient hardening occurs. FIGS. 1 and 2 show a spray bar 28 and coolant spray 36 emanating from spray nozzles 32 for this purpose.

The structure's framework may be also be built of hardenable steel; for example, air hardenable steel tubing could be used with great benefit for the framing members, as described in the application entitled Seam-welded Air Hardenable Steel Tubing (Ref. No. 4800-0004) filed concurrently herewith. In this case, since the frames would likely be already in a hardened condition, provision is made to insulate the frame from the hull skin when the skin is being heat treated, to prevent the frame from annealing. Such insulation can take the form, for example, of a layer permanently sandwiched between the skin and the frame, or an air gap temporarily provided by shifting the frame members inward during heat treating of the skin. In the preferred embodiment, the skin is fastened to the frame by flanges or studs made of non-air hardening steel welded to the inside surface of the skin and projecting inwards. The studs or flanges are then fastened to the frame by welding, or by the use of threaded fasteners.

1. A skinned structure wherein the skin is composed of welded hardenable steel plates or sheets.

2. The structure of claim 1, wherein the hardenable steel plates or sheets are of air hardenable stainless steel.

3. The structure of claim 1, wherein the hardenable steel plates or sheets are of liquid quench hardenable steel.

4. The structure of claim 1, wherein the skinned structure is a ship hull.

5. The structure of claim 1, wherein the skinned structure is a storage tank.

6. The structure of claim 1, wherein the skinned structure is an aircraft.

7. The structure of claim 1, wherein the skinned structure is a moving vehicle body.

8. The structure of claim 1, wherein the skinned structure is a building wall.

9. A method of constructing a skinned structure of air hardenable steel plates or sheets, the method comprising:
placing multiple annealed air hardenable steel plates or sheets over a framework;
welding the adjacent edges of the air hardenable steel plates or sheets to create a continuous skin;
controlling the cooling rate of each welded seam;
and heat-treating the entire skin to a high strength condition.

10. The method of claim 9, wherein the steel plates or sheets are of air hardenable stainless steel.

11. The method of claim 9, wherein the heat-treating is accomplished by a belt-like device comprising:
a continuous band of elements flexibly connected together;
heat inducing means mounted on each element;
means for supporting the belt in close contact to the surface of a structure;
and means for moving the belt from one end of the structure to the other.

12. The method of claim 11, the belt-like device further including cool air blast- or liquid spray cooling-nozzles mounted on the trailing edge of the device.

13. The method of claim 9, wherein said framework includes air hardenable steel;
and further including means to insulate the frame from the skin when the skin is being heat-treated.

14. The method of claim 13, wherein said means to insulate the frame is a layer permanently sandwiched between the frame and the skin.

15. The method of claim 13, wherein said means to insulate the frame comprises an air gap temporarily provided by shifting the frame members inward during heat treating of the skin.

16. The method of claim 13, wherein said air hardenable steel framework is fastened to the skin by flanges or studs welded to the skin.

17. A method of constructing a skinned structure of liquid quench hardenable steel plates or sheets, the method comprising:
placing multiple liquid quench hardenable steel plates or sheets over a framework;
welding the adjacent edges of the liquid quench hardenable steel plates or sheets to create a continuous skin;
and heat-treating the entire skin to a high strength condition.

18. The method of claim 17, wherein the heat-treating is accomplished by a belt-like device comprising:
a continuous band of elements flexibly connected together;
heat inducing means mounted on each element;
means for supporting the belt in close contact to the surface of a structure;
and means for moving the belt from one end of the structure to the other.

19. The method of claim 18, the belt-like device further including cool air blast- or liquid spray cooling-nozzles mounted on the trailing edge of the device.

20. The method of claim 17, wherein said framework includes air hardenable steel;
and further including means to insulate the frame from the skin when the skin is being heat-treated.

21. The method of claim 20, wherein said means to insulate the frame is a layer permanently sandwiched between the frame and the skin.

22. The method of claim 20, wherein said means to insulate the frame comprises an air gap temporarily provided by shifting the frame members inward during heat treating of the skin.
